(19) United States
(12) Patent Application Publication
(10) Pub. No.: US 2021/0163130 A1
(43) Pub. Date: Jun. 3, 2021

(54) MOUNTING MECHANISM, LANDING GEAR, FRAME, AND UNMANNED AERIAL VEHICLE

(71) Applicant: SZ DJI TECHNOLOGY CO., LTD., Shenzhen (CN)

(72) Inventors: Yanchen LIU, Shenzhen (CN); Yu LI, Shenzhen (CN)

(21) Appl. No.: 17/020,102

(22) Filed: Sep. 14, 2020

Related U.S. Application Data
(63) Continuation of application No. PCT/CN2018/079054, filed on Mar. 14, 2018.

(51) Int. Cl. B64C 39/02; B64C 25/06; B64D 47/08

(52) U.S. Cl. CPC B64C 39/024; B64C 25/06; B64C 2201/127; B64C 2201/027; B64D 47/08

(57) ABSTRACT

The present disclosure provides a mounting mechanism of a UAV. The mounting mechanism includes a rotating part rotatably connected with a center frame and connected with a landing gear; and a driving part driving the rotating part to rotate when a carrier for carrying a payload rotates.

### CROSS-REFERENCE TO RELATED APPLICATION

This application is a continuation of International Application No. PCT/CN2018/079054, filed on Mar. 14, 2018, the entire content of which is incorporated herein by reference.

### TECHNICAL FIELD

The present disclosure relates to the field of unmanned aerial vehicle (UAV) and, more specifically, to a mounting mechanism, a landing gear, a frame, and a UAV.

### BACKGROUND

The landing gear is an attachment that supports the UAV and enables various maneuvers of the UAV. It has an important role during the safe takeoffs and landings of the UAV, and is one or the important components of the UAV.

UAVs have been widely used in aerial photography, forest conservation projects, surveying and mapping, and other fields. In order to prevent the landing gear from bumping against fixed objects on the ground (such as trees, houses, etc.) during the flight of the UAV, the landing gear is generally designed to be retractable.

However, this type of retractable landing gear can be captured in the acquired images of the camera during the rotation of the gimbal. Therefore, some manufacturers fix the landing gear on the gimbal, such that when the gimbal rotates, the landing gear can be synchronously rotated to prevent the landing gear from being captured in the acquired images. However, fixedly connecting the landing gear to the gimbal can affect the stability of the gimbal, resulting in decreased imaging quality.

### SUMMARY

One aspect of the present disclosure provides a mounting mechanism of a UAV. The mounting mechanism includes a rotating part rotatably connected with a center frame of the UAV and connected with a landing gear disposed under the center frame; and a driving part driving the rotating part to rotate when a carrier disposed under the center frame for carrying a payload rotates.

Another aspect of the present disclosure provides a landing gear of a UAV. The landing gear is disposed under a center frame of the UAV, and includes a carrier disposed under the center frame for carrying a payload; and a mounting mechanism including a rotating part rotatably connected with the center frame and connected with the landing gear, and a driving part driving the rotating part to rotate when the carrier rotates.

Another aspect of the present disclosure provides a UAV. The UAV includes a landing gear disposed under a center frame of the UAV; a gimbal disposed under the center frame of the UAV for carrying a payload; and a mounting mechanism including a rotating part rotatably connected with the center frame and connected with the landing gear, and a driving part driving the rotating part to rotate when the carrier rotates.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a structural diagram of a UAV according to an embodiment of the present disclosure.

FIG. 2 is a diagram of a mounting mechanism according to an embodiment of the present disclosure.

FIG. 3 is a structural diagram of the mounting mechanism according to another embodiment of the present disclosure.

FIG. 4 is an exploded view of a driving part according to an embodiment of the present disclosure.

FIG. 5 is a structural diagram of another mounting mechanism according to an embodiment of the present disclosure.

FIG. 6 is a structural diagram of yet another mounting mechanism according to an embodiment of the present disclosure, in which a landing gear is mounted on the mounting mechanism.

FIG. 7 is a structural diagram of the mounting mechanism in FIG. 6 from another perspective.

FIG. 8 is an exploded view of FIG. 6, in which the lower half of the landing gear is cut off.

FIG. 9 is an exploded view of a support part and a rotating part in FIG. 8.

### REFERENCE NUMERALS

1 UAV
10 Center frame
30 Power assembly
50 Landing gear
60 Connector
70 Mounting mechanism
71 Rotating part
711 Driven gear
712 Rotating shaft
713a Upper cover
713b Lower cover
73 Driving part
731 Motor
731a Output shaft
732 Transmission gear
733 Transmission belt
734 Motor mounting base
735 Bearing support base
736 Second bearing
737 Motor protection cover
738 LED module
75 Support part
751 Supporting block
753 First bearing
7551a Upper support
7551b Lower support
7552 Ball
7553a Upper rail
7553b Lower rail
77 Dust cap
771 Mounting hole
773 Positioning protrusion
79 Dust cover
90 Gimbal
2 Imaging device

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

In the present disclosure, when terms such as “center,” “longitudinal,” “lateral,” “length,” “width,” “thickness,” “above,” “upper,” “below,” “lower,” “back,” “left,” “right,” “vertical,” “horizontal,” “top,” “bottom,” “inside,” “outside,” “internal,” “external,” “clockwise,” “counter-clockwise” are used to indicate orientational or positional relationship that is based on the orientation or positional relationship as shown in the drawings, it is for the convenience of describing various embodiments and for the simplification of the descriptions. Such terms do not indicate or imply a related device or element necessarily has the specified orientation, or is structurally configured in the specified orientation or is operated in the specified orientation. Thus, these terms are for illustrative purposes only and are not intended to limit the scope of the present disclosure.

It should be understood that in the present disclosure, relational terms such as first and second, etc., are only used to distinguish an entity or operation from another entity or operation, and do not necessarily imply that there is an actual relationship or order between the entities or operations. Therefore, a “first” or “second” feature may include, explicitly or implicitly, one or more such features. The term “multiple” means two or more than two, unless otherwise defined.

In the present disclosure, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements or interactions of two elements, which can be understood by those skilled in the art according to specific situations.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. In this specification, exemplary descriptions of aforesaid terms are not necessarily referring to the same embodiment or example. Furthermore, the particular features, structures, materials, or characteristics may be combined in any suitable manner in one or more embodiments or examples. Moreover, those skilled in the art could combine different embodiments or different characteristics in embodiments or examples described in the present disclosure. In addition, when there is no conflict, those skilled in the art may combine different embodiments, or examples and features of different embodiments, or examples described in the present disclosure.

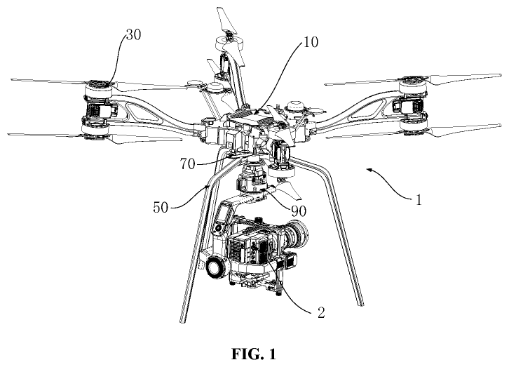

FIG. 1 is a structural diagram of a UAV according to an embodiment of the present disclosure. As shown in FIG. 1, a UAV 1 includes a center frame 10, which is the main part of the UAV 1. The center frame 10 generally includes a flight control system of the UAV 1 to control the flight status of the UAV 1, such as controlling the ascent, landing, steering, and hovering of the UAV 1. In some embodiments, the flight control system may be a microprocessor, a microcontroller, or an integrated circuit. The center frame 10 includes a top surface, a bottom surface and a plurality of side surfaces positioned between the top surface and the bottom surface. The space enclosed by the top surface, bottom surface, and the side surfaces may be used to mount the flight control system described above and a battery for powering the UAV 1, etc. Of course, in some embodiments, a mounting cavity for mounting the battery may also be formed by recessing the bottom surface of the center frame 10, and a battery cover may be detachably disposed at an opening of the mounting cavity.

A plurality of arms are generally evenly disposed around the center frame, and these arms may be symmetrical about the horizontal axis or the vertical axis of the center frame 10. For example, as shown in FIG. 1, four arms are disposed symmetrically about the horizontal axis and the vertical axis around the center frame 10. The arms may be fixedly connected to the center frame 10, and may also be rotationally connected to the center frame 10. Alternatively, the arms may be design to be folded relative to the center frame 10 to reduce the space occupied by the UA 1 when stored. For example, one end of the arm close to the center frame 10 may be inserted from the side of the center frame 10 between the top surface and the bottom surface of the center frame 10 to improve the connection strength between the arm and the center frame 10. It should be understood that although one end of the arm can be inserted into the center frame 10 from the side of the center frame 10 as described above, this arrangement may not affect the fixed connection or the rotational connection between the arm and the center frame center frame 10. The arm can be made into any suitable shape using any materials in conventional technology. For example, the arm can be made into a rod-shaped structure using metal (such as iron or aluminum) or non-metal (such as polymer plastic). Of course, in order to reduce the weight and improve the power performance of the UAV 1, the arm can be made of carbon fiber material into a hollow rod-like structure or a plate-like structure with weight-reducing holes (as shown in FIG. 1).

One or more power assemblies 30 can be mounted at the end of the arm away from the center frame 10 to provide power for the ascent, forward, hover, and rotation of the UAV 1. The power assembly 30 may include a propeller, a drive motor that drives the propeller to rotate, and an electronic speed control (ESC) that controls the operating parameters of the drive motor. It should be understood that when a plurality of power assemblies 30 are provided on the same arm of the UAV 1, these power assemblies 30 may be disposed on the arm at intervals along the extending direction of the arm, or two power assemblies 30 may also be disposed symmetrically at the end of the arm as shown in FIG. 1.

A carrier for carrying a payload may be mounted below the center frame 10, such that the UAV 1 can implement certain auxiliary function through the payload being carried. In some embodiments, the payload may be fixed to the bottom surface of the center frame 10 directly or through an adapter. In the present embodiment, the carrier may be a gimbal 90 that allows the payload to rotate about one or more rotation shafts 712 or provide stability to the payload or to control the state of the payload to rotate, translate, etc. The gimbal 90 in the present embodiment may include, but is not limited to, a single-axis gimbal, a dual-axis gimbal, and a three-axis gimbal. Of course, the carrier may also be other structures for carrying objects, such as a hanging basket or a mechanical claw.

In the present embodiment, the payload can refer to a payload or any part of the object supported by the gimbal 90. The payload can be configured to not perform any operation or function. Alternatively, the payload may be configured to perform a corresponding operation or function, which can be referred to as a functional payload. For example, the payload may include one or more sensors for surveying one or more targets. The sensor can collect information about the environment around the sensor. Any suitable sensor may be incorporated into the payload, such as an imaging device 2 (such as a visual imaging device including an image acquisition device and a camera, an ultraviolet imaging device, a thermal imaging device, etc.), an audio capturing device (such as a parabolic microphone), a radio frequency (RF) sensor, a magnetic sensor, an ultrasonic sensor, etc. In some embodiments, the payload may include a single type of sensor, emitter, and/or tool, or multiple types of sensors emitters, and/or tools. In addition, the payload may also include any number of sensors, emitters, and/or tools and combinations thereof, such as a sensor array.

In the following embodiments, an example will be described in which the carrier is a three-axis gimbal and the payload is an imaging device 2. In some embodiments, the three-axis gimbal may be a gimbal that can rotate around a first axis (e.g., a yaw axis), a second axis (e.g., a roll axis), and a third axis (e.g., a pitch axis). When the three-axis gimbal rotates around the yaw axis, the imaging device 2 supported by the three-axis gimbal may also rotate synchronously about the yaw axis.

A plurality of landing gears 50 may also be disposed below the center frame 10 to support the UAV 1 when the UAV 1 lands on the ground or other ground fixed objects, thereby preventing the main structures, such as the center frame 10 of the UAV 1 from contacting the ground or ground fixed objects to protect the UAV 1. Generally, the landing gear 50 may be made of carbon fiber material into a hollow rod-like structure to reduce the weight and improve the power performance of the UAV 1. Of course, the embodiments of the present disclosure do not exclude the use of other lightweight, high-strength, or other material to make the landing gear 50.

Although the carbon fiber material is used to make the landing gear 50, when the landing gear 50 is fixed on the gimbal 90 to prevent the landing gear 50 from entering the imaging range (hereinafter referred to as the image) of the imaging device 2 carried by the gimbal 90, some manufacturers have fixed the landing gear 50 on the gimbal 90. As such, when the gimbal 90 rotates, the landing gear 50 can also rotate synchronously to ensure that the landing gear 50 does not appear in the image of the imaging device 2. However, the gimbal 90 of this UAV 1 needs to rotate the landing gear 50 at the same time as it drives the imaging device carried by the gimbal 90. Although the quality of the landing gear 50 has been reduced through the selection of materials, the landing gear 50 will still affect the modalities of the gimbal 90 itself, resulting in reduced stability of the gimbal 90, which in turn affects the imaging quality of the imaging device 2. For example, the image of the imaging device 2 may become blurry, and the stability of the gimbal 90 itself may be reduced, which can cause safety concerns of the imaging device 2 carried by the gimbal 90.

In view of the above, an embodiment of the present disclosure further provides a mounting mechanism 70 disposed below the center frame 10 for mounting the landing gear 50 described above. A part of the mounting mechanism 70 (hereinafter referred to as a rotating part 71) may be rotatably connected to the center frame 10. That is, the rotating part 71 can rotate relative to the center frame 10, and the landing gear 50 may be fixed to the rotating part 71. As such, the rotating part 71 may rotate relative to the center frame 10 to adjust the position of each landing gear 50 relative to the center frame 10, thereby preventing the landing gear 50 from appearing in the image of the imaging device 2 when the gimbal 90 drives the imaging device to rotate. In addition, since the landing gear 50 is fixed to the rotating part 71 of the mounting mechanism 70, the gimbal 90 does not need to drive the landing gear 50 rotate when it rotates, which can improve the stability of the gimbal 90 and the imaging quality of the imaging device 2.

More specifically, in some embodiments, the rotating part 71 of the mounting mechanism 70 and the gimbal 90 may be both connected to the flight control system. The flight control system can send control signals to the mounting mechanism 70 and the gimbal 90 to control the rotation of the yaw axis of the rotating part 71 and the gimbal 90. For example, control the rotation of the yaw axis of the rotating part 71 and the gimbal 90 to rotate synchronously. That is, the rotation direction and rotation speed of the yaw axis of the rotating part 71 and the gimbal 90 may be the same, such that the landing gear 50 may also rotate synchronously when the gimbal 90 rotates, thereby preventing the landing gear 50 from entering the image of the imaging device 2 carried by the gimbal 90. Of course, the flight control system can also control the yaw axis of the rotating part 71 and the gimbal 90 to rotate at different angles, as long as the landing gear 50 does not enter the image of the imaging device 2 during the rotation of the gimbal 90. It should be understood that when other payloads are carried by the gimbal 90, such as other sensors, the yaw axis of the rotating part 71 and the gimbal 90 can be controlled to rotate synchronously or by different angles through the flight control system, such that the landing gear 50 may not interfere with other payloads, such as not blocking the sensing area of a RF sensor, etc. In addition, although the above description is directed to the flight control system controlling the rotation of the rotating part 71 and the gimbal 90, in some embodiments, the rotation of the rotating part 71 and the gimbal 90 may also be controlled by a remote controller or a ground station wireless connected to the UAV 1. Of course, the remote controller may directly control the rotating part 71 and the gimbal 90, or indirectly through the flight control system.

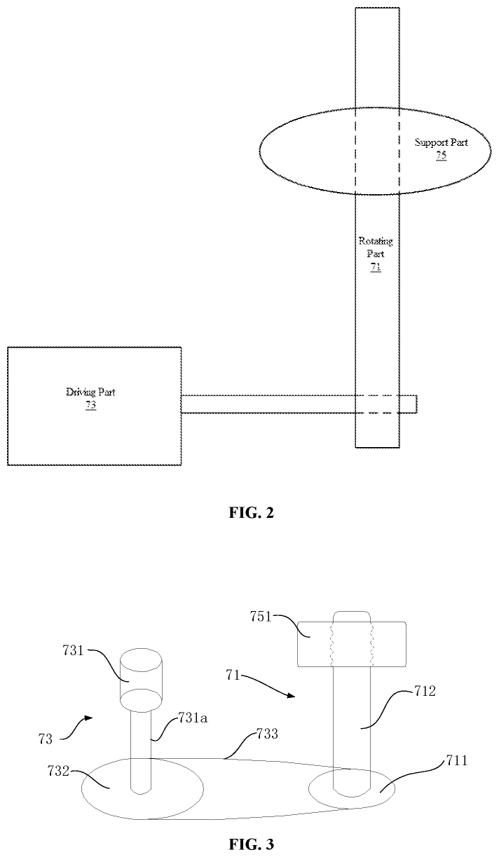

FIG. 2 is a diagram of a mounting mechanism according to an embodiment of the present disclosure. As shown in FIG. 2, in order to drive the rotating part 71 to rotate relative to the center frame 10 to adjust the relative position of the landing gear 50 fixed to the rotating part 71 and the center frame 10, such that the landing gear 50 may not enter the image of the imaging device 2 carried by the gimbal 90, the mounting mechanism 70 may further include a driving part 73. The driving part 73 may be used to drive the rotating part 71 to rotate when the gimbal 90 rotates. It should be understood that the driving part 73 may be used only to drive the rotating part 71 to rotate, or may be used to simultaneously drive the rotating part 71 and the gimbal 90 to rotate. In addition, in order to support the driving part 73 and realize the rotatable connection of the rotating part 71 and the center frame 10, a support part 75 may be disposed on the rotating part 71 to fixedly connect to the center frame 10. More specifically, the support part 75 ad the bottom surface of the 10 may be fixed by bolts, screws, rivets, or the like. The rotating part 71 may be connected to the support part 75 and may rotate relative to the support part 75.

Several mounting mechanisms 70 will be described below, but those skilled in the art should understand that these mounting mechanisms 70 are exemplary and not specific limitations of the present disclosure. If a person skilled in the art replaces or combines one or more components in the following mounting mechanisms 70, or replaces or combines one or more technical features, etc., it should be considered as within the protection scope of the claims of the present disclosure.

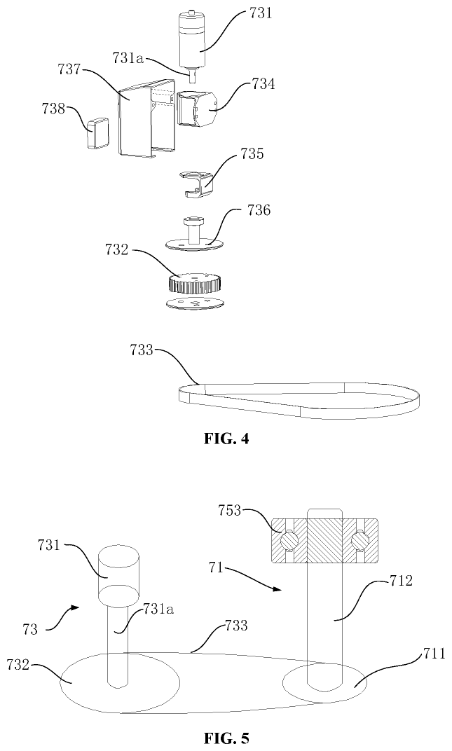

FIG. 3 is a structural diagram of the mounting mechanism according to another embodiment of the present disclosure, and FIG. 4 is an exploded view of a driving part 73 according to an embodiment of the present disclosure. As shown in FIGS. 3 and 4, in the present embodiment, the rotating part 71 includes a rotating shaft 712 and a driven member drivenly connected to the driving part 73, and the driven member includes, but is not limited to, a driven wheel or a driven gear 711. The bottom of the rotating shaft 712 is fixed to the driven member, and the top of the rotating shaft 712 is rotatably connected to the support part 75. The driving part 73 may include a motor 731 and a transmission component. The motor 731 may be connected to the driven member through the transmission component, such that the motor 731 can drive the driven member to rotate to adjust the position of the landing gear 50 fixed on the rotating shaft 712.

Still referring to FIGS. 3 and 4, the transmission component may include a first transmission member mounted on the output shaft of the motor, and a second transmission member for drivingly connecting the first transmission member and the driven member. For example, the first transmission member may be a transmission wheel or a transmission gear 722, the second transmission member may be a transmission belt 733, a transmission chain, or a transmission gear, and the driven member may be a driven wheel or the driven gear 711. Taking the first transmission member as the transmission gear 732, the second transmission member as the transmission belt 733, and the driven member as the driven gear 711 as an example, the transmission gear 732 may be mounted on an output shaft 731a of the motor 731, the driven gear 711 ma be fixed to the bottom of the rotating shaft 712, and the transmission belt 733 may be sleeved on the outside of the transmission gear 732 and the driven gear 711 to transmit the torque of the motor 731 to the rotating shaft 712. It should be understood that the inner surface of the transmission belt 733 may be provided with teeth matching the transmission gear 732 and the driven gear 711 to avoid slippage of the transmission belt 733 and improve the transmission stability.

In the present embodiment, the motor 731 may be directly fixed on the center frame 10, or the driving part 73 may further include a support base fixedly connected to the center frame 10 (as shown in FIG. 4). The motor 731 may be mounted on the support base. For example, in some embodiments, the support base may include a motor mounting base 734 and a bearing support base 735. In particular, support base of the motor 731 may be fixedly connected to the center frame 10 (e.g., support base of the motor 731 may be fixed to the side of the center frame 10). The motor 731 may be mounted on the motor mounting base 734, the bearing support base 735 may be mounted below the support base of the motor 731. A second bearing 736 may be mounted on the bearing support base 735, and the output shaft 731a of the motor 731 may pass through the second bearing 736 and be fixed to the transmission member (e.g., to the transmission gear 732 described above). Based on the above description, by providing the bearing support base 735 and the second bearing 736, the rigidity of the transmission gear 732 can be improved and the deformation of the transmission gear 732 can be reduced, thereby avoiding slippage of the transmission belt 733 during transmission and improving the reliability of the belt transmission.

In some embodiments, as shown in FIG. 4, in order to protect the motor 731 of the driving part 73, the driving part 73 further includes a motor protection cover 737, which is disposed on the outside of the motor 731. In some embodiments, the motor protection cover 737 may include an LED module 738 for indicating the flight control state and/or power state of the UAV, and alarm when the flight control state and/or power state of the UAV is abnormal. For example, when the LED module 738 of the driving part 73 is turned on, the LED module 738 disposed on the motor protection cover 737 may display the flight control state and/or power state of the UAV to the user by lighting, changing colors, and blinking. Of course, if the flight control state and/or power state of the UAV is abnormal, the user can also be alerted by the color or the flashing time of the LED module 738.

In some embodiments, the driving part 73 may be disposed at the rear of the UAV, such that the user may observe the LED module 738. At the same time, an interface may be disposed on the LED module 738, which can be used to connect the parameter adjustment cable of the flight control parameters of the UAV.

In the present embodiment, the support part 75 may be directly fixed on the bottom surface of the center frame 10 or formed as an integral piece with the bottom surface of the center frame 10 by integral molding. More specifically, the support part 75 may be a supporting block 751 or other structures described below, such as a first bearing 753. Taking the supporting block 751 as an example, it may form a matching structure with the top of the rotating shaft 712, such that the rotating shaft 712 may rotate relative to the supporting block 751.

For example, the fitting structure described above may be a screw connection structure as shown in FIG. 3. That is, the top of the rotating shaft 712 is screwed to the supporting block 751. More specifically, a mounting hole is formed on the supporting block 751, an internal thread is formed on the inner wall of the mounting hole, and an external thread matching the internal thread is formed on the top of the rotating shaft 712. As such, when the transmission belt 733 drives the driven gear 711 to rotate, the top of the rotating shaft 712 fixed connected to the driven gear 711 can also rotate in the mounting hole through the screw fitting structure described above.

Further, the fitting structure described above may include one or more teeth formed on the top of the rotating shaft 712, and one or more teeth formed on the supporting block 751 that mesh with the one or more teeth formed on the top of the rotating shaft 712. More specifically, an upper gear may be mounted at the top of the rotating shaft 712, and a mounting hole may be formed in the supporting block 751. A plurality of teeth formed in a closed ring shape and meshing with the teeth on the upper gear at the top of the rotating shaft 712 may be formed on the inner wall of the mounting hole.

FIG. 5 is a structural diagram of another mounting mechanism according to an embodiment of the present disclosure. As shown in FIG. 5, in the present embodiment, the support part 75 is the first bearing 753 fixed to the bottom surface of the center frame 10, and at least a part of the rotating part 71 in stalled in the first bearing 753. As such, the rotating part 71 may rotate around the axis of the first bearing 753 to rotate the landing gear 50 fixedly connected to the rotating part 71, thereby preventing the landing gear 50 from entering the image of the imaging device 2.

In some embodiments, the first bearing 753 may be a ball bearing fixed on the bottom surface of the 10. The rotating part 71 may include a club and a driven member, the head of the club may be accommodated in a ball socket of the ball bearing, such that the club may rotate relative to the ball bearing. The other end of the club may be fixed to the driven member, and the club may be further used to fix the landing gear 50. In the present embodiment, the driven member fixed to the other end of the club may be a driven wheel or the driven gear 711, such that when the driving part 73 drives the driven member to rotate (e.g., when the transmission belt 733 drives the driven gear 711 as the driven member to rotate), the head of the club fixed to the driven member may rotate in the ball socket of the ball bearing. As such, the landing gear 50 fixed on the club may follow the club to avoid entering the image of the imaging device 2 carried by the gimbal 90. Of course, the other end of the rotating part 71 may not be provided with a driven member, and the transmission connection with the driving part 73 may be realized in other ways. In the present embodiment, the driving part 73 may be the driving part 73 described in the above embodiment, which will not be repeated here. For details, reference may be made to the content of the above embodiment.

In other embodiments, the first bearing 753 may be a sliding bearing or a rolling bearing fixed on the bottom surface of the center frame 10. In the present embodiment, the sliding bearing or the rolling bearing may be a sliding bearing or a rolling bearing generally used in conventional technology. For example, a ball bearing or a roller bearing may be used. Of course, this embodiment does not exclude the use of other structures having the same principle as the sliding bearing or rolling bearing of this embodiment, such as a rolling bearing with improved structure, which will be described below. During installation, the sliding bearing or rolling bearing may be fixed to the bottom surface of the center frame 10 through a bearing housing, or a mounting hole can be formed on the bottom surface of the center frame 10, and then the sliding bearing or rolling bearing may be installed in the mounting hole.

In the present embodiment, the rotating part 71 may include the rotating shaft 712 whose top may be mounted in a sliding bearing or a rolling bearing, and a driven member fixed to the bottom surface of the rotating shaft 712 and drivingly connected to the driving part 73, the driven member may be a driven wheel or the driven gear 711. Of course, this embodiment also does not exclude the use of other structures having the same principle as the rotating shaft 712 and he driven member as the rotating part 71 of this embodiment, such as an improved rotating part 71, which will be described below. It should be noted that the driving part 73 may be the driving part 73 described in the above embodiment, which will not be repeated here. For details, reference may be made to the content of the above embodiment.

The following takes the flight control system controlling the driving part 73 to drive the rotating part 71 to rotate as an example to briefly describe the working processing of the mounting mechanism 70 to drive the landing gear 50 to rotate. In particular, the driving part 73 may include the motor 731, the transmission gear 732, and the transmission belt 733; the rotating part 71 may include the driven gear 711 and the rotating shaft 712; and the support part 75 may be a rolling bearing.

The flight control system may send a control signal to the motor 731 of the driving part 73 based on information such as the rotation speed and rotation direction that the yaw axis of the gimbal 90 needs to rotate. The motor 731 may rotate based on the control signal, thereby driving the transmission gear 732 to rotate. Subsequently, the transmission belt 733 sleeved on the transmission gear 732 and the driven gear 711 fixed at the bottom of the rotating shaft 712 may transmit the torque of the transmission gear 732 to the driven gear 711, such that the driven gear 711 may drive the rotating shaft 712 fixed on the driven gear 711 to rotate in the rolling bearing, thereby driving the landing gear 50 fixedly connected to the rotating shaft 712 to rotate. As such, the landing gear 50 may be located outside the image of the imaging device 2 carried by the gimbal 90.

In some embodiments, the rotating shaft 712 described above can be designed as a hollow shaft, such that the adapter connected to the gimbal 90 can pass through the hollow shaft and be fixed to the bottom surface of the center frame 10. By designing the rotating shaft 712 as a hollow shaft in order to pass the adapter of the gimbal 90 through the hollow shaft, on one hand, can protect a connector 60 of the gimbal 90, and on the other hand, can reduce the wind resistance of the UAV 1 in flight. From a visual point of view, reducing the number of exposed parts can further enhance the aesthetics of the UAV 1. Based on the above, by designing the rotating part 71 as a hollow structure along the axial direction, the adapter for connecting the carrier may pass through the hollow structure, which can not only protect the adapter, but also reduce the wind resistance and improve the appearance of the UAV 1.

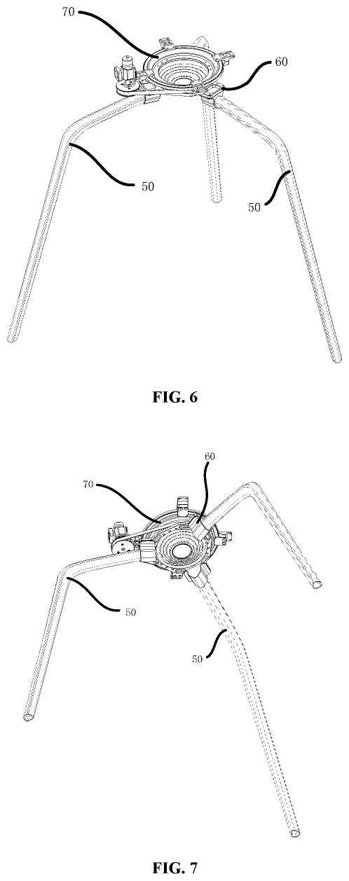

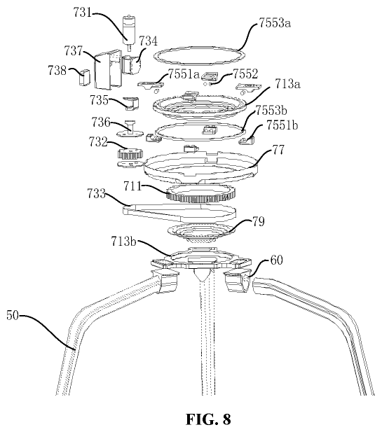

FIG. 6 is a structural diagram of yet another mounting mechanism according to an embodiment of the present disclosure, in which the landing gear 50 is mounted on the mounting mechanism. FIG. 7 is a structural diagram of the mounting mechanism in FIG. 6 from another perspective. FIG. 8 is an exploded view of FIG. 6, in which the lower half of the landing gear is cut off. As shown in FIGS. 6-8, the mounting mechanism 70 includes a driving part 73, a support part 75, a rotating part 71, a dust cap 77, and a dust cover 79, where the driving part 73 is the same as the structure of the above embodiment. For details, reference may be made to the above description, which will not be repeated here. The support part 75 includes an upper support 7551a, a lower support 7551b, an upper slide rail 7553a, a lower side rail 7553b, and a ball 7552. The rotating part 71 includes an upper cover 713a, a driven gear 711, and a lower cover 713b.

For the convenience of description, the parts other than the driving part 73 in FIG. 8 will be described separately in order from top to bottom.

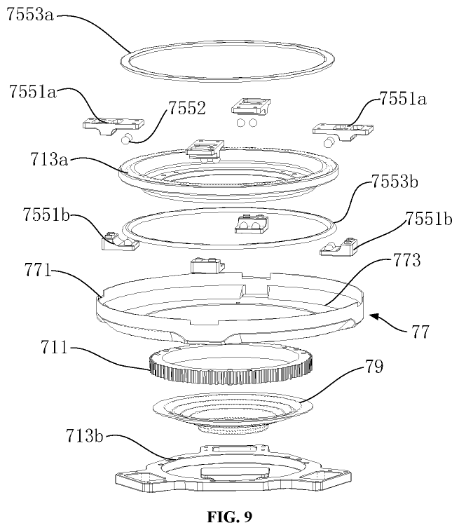

FIG. 9 is an exploded view of a support part and a rotating part in FIG. 8. Referring to FIGS. 8 and 9, in the present embodiment, the upper support 7551a is disposed at the uppermost end and forms a fixed connection with the bottom surface of the center frame 10. The upper slide rail 7553a is disposed under the upper support 7551a, and the ball 7552 is disposed between the upper support 7551a and the upper slide rail 7553a, such that the upper slide rail 7553a can rotate relative to the upper support 7551a. The upper cover 713a is disposed under the upper slide rail 7553a, and the lower slide rail 7553b is disposed under the upper cover 713a. That is, the upper cover 713a is clamped between the upper slide rail 7553a and the lower slide rail 7553b. The lower support 7551b is disposed under the lower side rail 7553b, and the lower support 7551b and the upper support 7551a are fixedly connected by bolts, screws, or rivets. The ball 7552 is disposed between the lower slide rail 7553b and the lower support 7551b, such that the lower slide rail 7553bj can rotate relative to the lower support 7551b. In addition, since the upper cover 713a is sandwiched between the upper slide rail 7553a and the lower side rail 7553b, the upper slide rail 7553a, the upper cover 713a, and the lower slide rail 7553b can rotate relative to the upper support 7551a and the lower support 7551b as a whole.

In other words, in the present embodiment, the upper support 7551a and the lower support 7551b can be considered as an outer ring of the rolling first bearing 753 as a whole, and the upper slide rail 7553a and the lower side rail 7553b can be considered as an inner ring of the rolling first bearing 753 as a whole. That is, in some variations, the rolling first bearing 753 may include a support for fixing with the center frame 10 and a slide rail for holding the contact position of the rotating part 71. The ball 7552 may be disposed between the slide rail and the support, such that the rotating part 71 tightly connected to the slide rail can rotate relative to the support.

The slide rail can be of any shape. For example, both the upper slide rail 7553a and the lower slide rail 7553b may be selected as round slide rails, curved slide rails, or hollow circular slide rails.

Still referring to FIGS. 8 and 9. In some embodiments, there may be a plurality of upper supports 7551a, and the plurality of upper supports 7551a may be evenly arranged on the outer edge of the upper slide rail 7553a to increase the supporting force to make the upper slide rail 7553a more stable. Similarly, there may be a plurality of lower supports 7551b, and the plurality of lower supports 7551b may be evenly arranged on the lower slide rail 7553b. For example, FIGS. 8 and 9 illustrate a specific example of four upper supports 7551a evenly disposed along the outer edge of the upper slide rail 7553a, and four lower supports 7551b evenly disposed along the outer edge of the lower slide rail 7553b. Of course, this embodiment also does not exclude making the upper supports 7551a and the lower supports 7551b into a ring shape.

Further, a plurality of balls 7552 may be disposed between the upper supports 7551a and the upper slide rail 7553a. For example, two balls 7552 may be disposed between the upper supports 7551a and the upper slide rail 7553a. That is, when there are a plurality of upper supports 7551a, two balls 7552 may be disposed between each upper support 7551a and the upper slide rail 7553a. For example, FIGS. 8 and 9 illustrate four upper supports 7551a and two balls 7552 being disposed between each upper support 7551a and the upper slide rail 7553a. By disposing a plurality of balls 7552 between the upper support 7551a and the upper slide rail 7553a, the rotational resistance of the upper slide rail 7553a can be reduced. Similarly, a plurality of balls 7552 may be disposed between the lower supports 7551b and the lower slide rail 7553b. For example, FIGS. 8 and 9 illustrate four lower supports 7551b and two balls 7552 being disposed between each upper support 7551b and the lower slide rail 7553b.

Still referring to FIGS. 8 and 9. The dust cap 77 may be disposed on the outside of the upper slide rail 7553a and the lower slide rail 7553b, such that the upper slide rail 7553a and the lower slide rail 7553b may be accommodated in the dust cap 77 to prevent dusting from falling onto the upper slide rail 7553a and the lower slide rail 7553b and affecting the rotation of the upper slide rail 7553a and the lower slide rail 7553b.

Further, in order to cooperate with the upper support 7551a and the lower support 7551b, a mounting hole 771 may be disposed at the top of the dust cap 77, and parts of the upper support 7551a and the lower support 7551b used to cooperate with the balls 7552 may extend into the dust cap 77 through the mounting hole 771. It should be understood that to prevent the dust cap 77 from falling, the dust cap 77 can be directed fixed on the bottom surface of the center frame 10 by bolts, screws, or other fasteners. Alternatively, the dust cap 77 and the lower support 7551b may be fixedly connected. In addition, parts of the upper support 7551a and the lower support 7551b are located outside the dust cap 77 in this embodiment, in other embodiments, the upper support 7551a and the lower support 7551b may be completely accommodated in the dust cap 77. At this time, the dust cap 77 may be fixed to the bottom surface of the center frame 10 by bolts, screw, or other fasteners. Further, a plurality of positioning protrusions 773 may be formed in the dust cap 77, and the lower support 7551b can be disposed at intervals with the positioning protrusions to reduce the shear force on the screw when the lower support 7551b is connected to the dust cap 77. Furthermore, a positioning groove matching the positioning protrusions may be formed on the lower surface of the upper cover 713a.

Still referring to FIGS. 8 and 9. The driven gear 711 that is in driving connection with the driving part 73 may be disposed below the upper cover 713a. Of course, the driven gear 711 may be replace with a driven wheel as the driven member that is driving connected to the driving part 73. In addition, if the dust cap 77 is disposed outside the slide rail, the driven wheel should be disposed under the dust cap 77 to facilitate the transmission connection with the driving part 73.

The lower cover 713b for attaching the landing gear 50 may be disposed below the driven gear 711, and the dust cover 79 as shown in FIGS. 8 and 9 may be selectively sandwiched between the lower cover 713b and the driven gear 711. The upper cover 713a, the driven gear 711, and the lower cover 713b may be fixedly connected by fixing pins, bolts, rivets, etc., such that when the transmission belt 733 of the driving part 73 drives the driven gear 711 to rotate, the upper cover 713a and the lower cover 713b fixedly connected to the driven gear 711 may also rotate correspondingly. More specifically, the upper cover 713a may rotate with the upper slide rail 7553a and the lower slide rail 7553b relative to the upper support 7551a and the lower support 7551b, respectively. Of course, in the present embodiment, the driven gear 711 may be replaced by a driven wheel or other components.

It should be understood that the upper cover 713a and the lower cover 713b of the rotating part 71, and the dust cover 79 sandwiched between the lower cover 713b and the driven gear 711 are not necessarily required structures. For example, in some variations, the rotating part 71 may not include the lower cover 713b. At this time, the landing gear 50 may be fixed on the upper cover 713a or the driven gear 711 (such as the lower surface of the driven gear 711). That is, in the present embodiment, the rotating part 71 may include an end cover and a driven member, where the end cover may include only the upper cover 713a, or both the upper cover 713a and the lower cover 713b; and the driven member may be a driven wheel or the driven gear 711. More specifically, the end cover may be sandwiched between the upper slide rail 7553a and the lower slide rail 7553b, or rotatably connected to the upper slide rail 7553a and/or the lower slide rail 7553b; the driven member may be fixed to the end cover; and the landing gear 50 may be fixed to the end cover.

Further, in some variations, the rotating part 71 may not include the upper cover 713a. At this time, the landing gear 50 may be fixed to the driven gear 711 or an intermediate piece connected to the driven gear 711, and the driven gear 711 may be fixed to the upper slide rail 7553a and/or the lower slide rail 7553b, such that the driven gear 711 may rotate relative to the upper slide rail 7553a and/or the lower slide rail 7553b.

Still referring to FIG. 8, an attachment part may be formed on the lower cover 713b, and the landing gear 50 may be attached to the attachment part via a connector 60.

It should be noted that the upper slide rail 7553a, the lower slide rail 7553b, the upper cover 713a, the lower cover 713b, and the driven gear 711 may be made into a hollow structure. That is, the slide rails, end covers, and the driven member may be made into a hollow structure for the adapter of the gimbal 90 to pass through. With this arrangement, on one hand, the UAV 1 may include an adapter, and on the other hand, the wind resistance of the UAV 1 in flight may be reduced. From a visual point of view, reducing the number of exposed parts can further enhance the aesthetics of the UAV 1.

In addition, an embodiment of the present disclosure further provides a UAV landing gear, which includes the mounting mechanism 70 and the landing gear 50 described above. Further, an embodiment of the present disclosure also provides a UAV frame, which includes the landing gear 50 and the center frame 10 described above. That is, the UAV of this embodiment may include the frame and the gimbal disposed under the frame described above.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A mounting mechanism of a UAV, comprising:
a rotating part rotatably connected with a center frame of the UAV and connected with a landing gear disposed under the center frame; and,
a driving part driving the rotating part to rotate when a carrier disposed under the center frame for carrying a payload rotates.

2. The mounting mechanism of claim 1, wherein:
the carrier is a gimbal, and the payload is an imaging device.

3. The mounting mechanism of claim 1, wherein:
the rotating part is a hollow structure along an axial direction for an adapter to pass through, the adaptor connecting the carrier and the center frame.

4. The mounting mechanism of claim 1, further comprising:
a support part to fixedly connect with the center frame, and the rotating part is rotatably connected with the support part.

5. The mounting mechanism of claim 4, wherein:
the support part is a first bearing, and a part of the rotating part is installed in the first bearing for the rotating part to rotate around an axis of the first bearing.

6. The mounting mechanism of claim 5, wherein:
the first bearing is a rolling bearing;
the rolling bearing includes a support for fixing with the center frame, a slide rail to hold a contact position of the rotating part; and
a plurality of balls are disposed between the support and the slide rail.

7. The mounting mechanism of claim 6, wherein:
the support includes an upper support and a lower support, and the slide rail includes an upper slide rail and a lower slide rail;
the balls are disposed between the upper support and the upper slide rail, and between the lower support and the lower slide rail; and,
a part of the rotating part is disposed between the upper slide rail and the lower slide rail.

8. The mounting mechanism of claim 7, wherein:
the upper support includes a plurality of upper supports, the plurality of upper supports are evenly disposed on an outer edge of the upper slide rail;
the lower support includes a plurality of lower supports, the plurality of lower supports are evenly disposed on an outer edge of the lower slide rail;
the plurality of balls are disposed between the upper support and the upper slide rail; and,
the plurality of balls are disposed between the lower support and the lower slide rail.

9. The mounting mechanism of claim 6, wherein the rotating part includes:
a driven member, the driven member being connected to the driving part and rotatably connected to the support part;
an end cover including an upper cover and a lower cover, the driven member is fixed and disposed between to the upper cover and the lower cover, the upper cover is rotatably connected to the support part, and the lower cover is used to fix the landing gear.

10. The mounting mechanism of claim 9, further comprising:
a dust cover being sandwiched between the driven member and the lower cover.

11. The mounting mechanism of claim 9, wherein:
the slide rail, the end cover, and the driven member have a hollow structure and are used for passing the adapter connecting the carrier and the center frame.

12. The mounting mechanism of claim 6, further comprising:
a dust cap for accommodating the slide rail and the dust cap being fixing with the support.

13. The mounting mechanism of claim 12, wherein:
a mounting hole is formed at the top of the dust cover, and a part of the support for cooperating with the balls extends through the mounting hole into the dust cover.

14. The mounting mechanism of claim 5, wherein:
the support part and the center frame are an integrally formed piece.

15. The mounting mechanism of claim 1, wherein:
The driving part includes a motor and a transmission, and the motor is connected to the rotating part through the transmission.

16. The mounting mechanism of claim 15, wherein:
the transmission includes a transmission gear and a transmission belt, the transmission gear being fixed to an output shaft of the motor and drivingly connected to the rotating part through the transmission belt; and,
the driving part further includes a support base, the support being fixed on the center frame, the motor being fixed on the support base.

17. The mounting mechanism of claim 15, wherein:
the driving part further includes a motor protection cover disposed outside the motor; and
an LED module is disposed on the motor protection cover, the LED module being configured to indicate a flight state and/or power state of the UAV.

18. The mounting mechanism of claim 15, wherein:
the carrier is a gimbal and the motor is used to drive a yaw axis of the gimbal.

19. A landing gear of a UAV, comprising:
the landing gear disposed under a center frame of the UAV;
a carrier disposed under the center frame for carrying a payload; and,
a mounting mechanism including a rotating part rotatably connected with the center frame and connected with the landing gear, and a driving part driving the rotating part to rotate when the carrier rotates.

20. A UAV, comprising:
a landing gear disposed under a center frame of the UAV;
a gimbal disposed under the center frame of the UAV for carrying a payload; and
a mounting mechanism including a rotating part rotatably connected with the center frame and connected with the landing gear, and a driving part driving the rotating part to rotate when the carrier rotates.
